(19) United States
(12) Patent Application Publication
(10) Pub. No.: US 2016/0038959 A1
(43) Pub. Date: Feb. 11, 2016

(54) Dual Compartment Dispensing Device

(71) Applicants: Flavio Lopez, Hammond, IN (US); Carolina Lopez, Hammond, IN (US)

(72) Inventors: Flavio Lopez, Hammond, IN (US); Carolina Lopez, Hammond, IN (US)

(21) Appl. No.: 14/451,635

(22) Filed: Aug. 5, 2014

(51) Int. Cl. B05B 11/00

(52) U.S. Cl. CPC B05B 11/3011; B05B 11/0089; B05B 11/0037; B05B 11/3047

(57) ABSTRACT

A dual compartment dispensing device allows multiple fluids to be individually dispensed. The device includes a container having a bottom wall and a perimeter wall coupled to and extending upwardly from the bottom wall. A top edge of the perimeter wall defines an opening into the container. A dividing wall is positioned in the container defining a first compartment for receiving a first fluid and a second compartment for receiving a second fluid. A dispensing head is positionable to cover the opening. A first pump is mounted on the dispensing head and is in fluid communication with the first compartment for dispensing the first fluid from the first compartment. A second pump is mounted on the dispensing head and is in fluid communication with the second compartment for dispensing the second fluid from the second compartment.

### BACKGROUND OF THE DISCLOSURE

### Field of the Disclosure

The disclosure relates to fluid dispensing devices and more particularly pertains to a new fluid dispensing device for allowing multiple fluids to be stored in and dispensed from a single container without mixing of the fluids.

### SUMMARY OF THE DISCLOSURE

An embodiment of the disclosure meets the needs presented above by generally comprising a container having a bottom wall and a perimeter wall coupled to and extending upwardly from the bottom wall. A top edge of the perimeter wall defines an opening into the container. A dividing wall is positioned in the container defining a first compartment for receiving a first fluid and a second compartment for receiving a second fluid. A dispensing head is positionable to cover the opening. A first pump is mounted on the dispensing head and is in fluid communication with the first compartment for dispensing the first fluid from the first compartment. A second pump is mounted on the dispensing head and is in fluid communication with the second compartment for dispensing the second fluid from the second compartment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front partial cut-way view of a dual compartment dispensing device according to an embodiment of the disclosure.

FIG. 2 is a cross-sectional view of an embodiment of the disclosure taken along line 2-2 of FIG. 1.

FIG. 3 is a partial cut-away view of an embodiment of the disclosure.

FIG. 4 is a top front side perspective view of a container of an embodiment of the disclosure.

FIG. 5 is a front view of an embodiment of the disclosure.

### DESCRIPTION OF THE PREFERRED EMBODIMENT

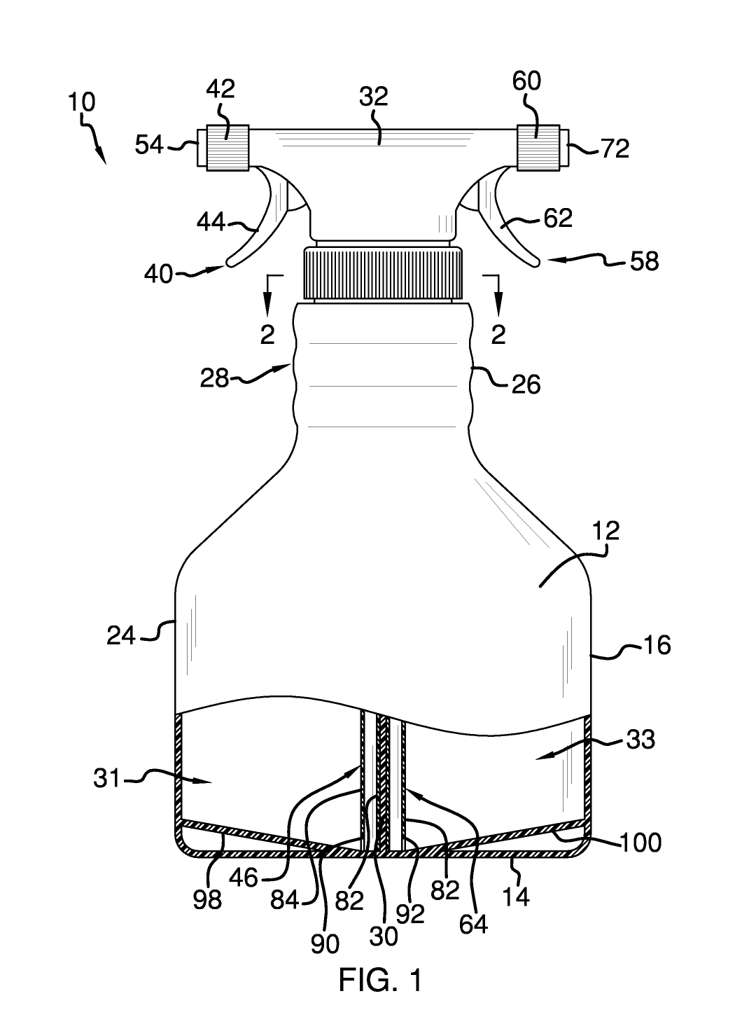

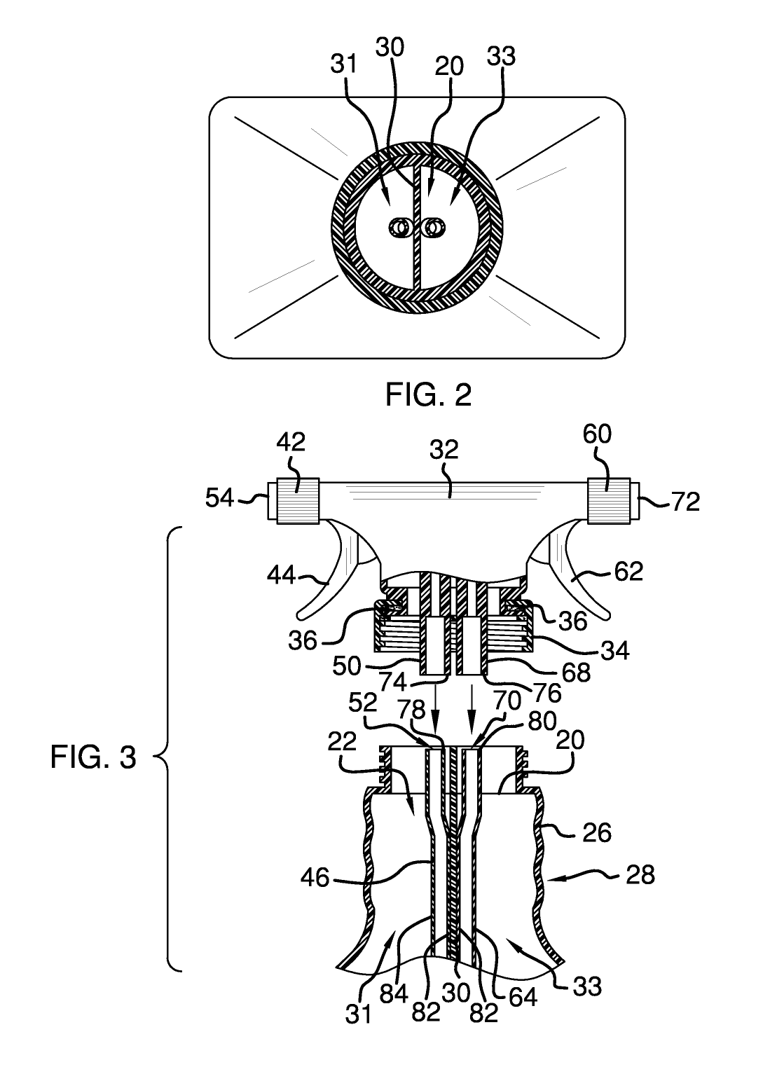

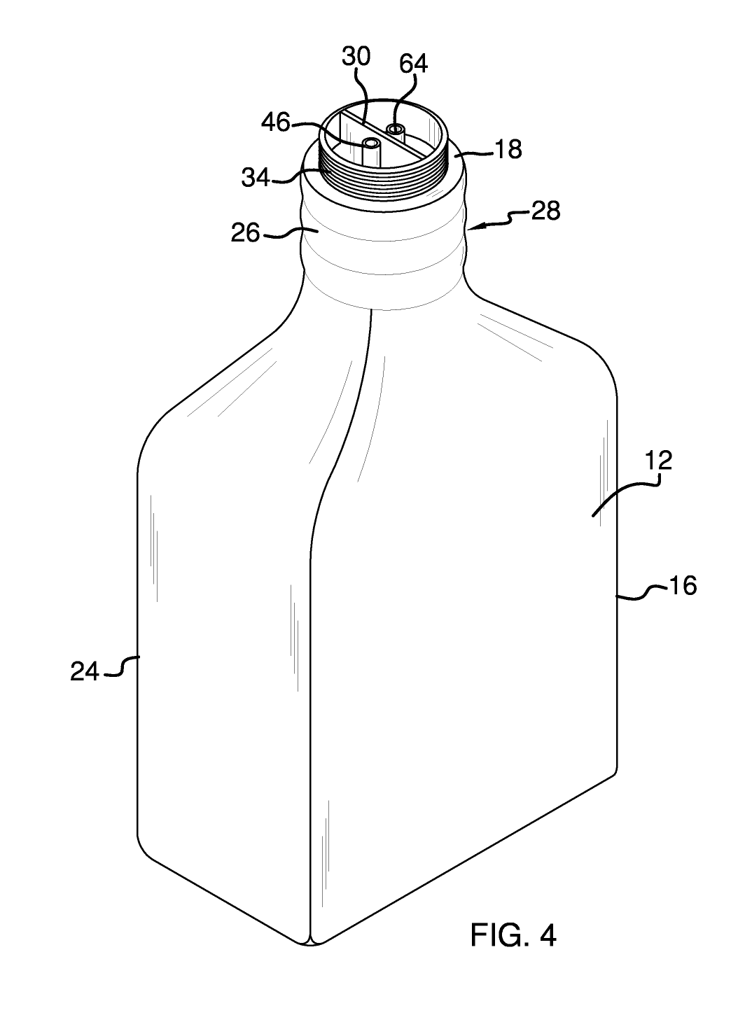

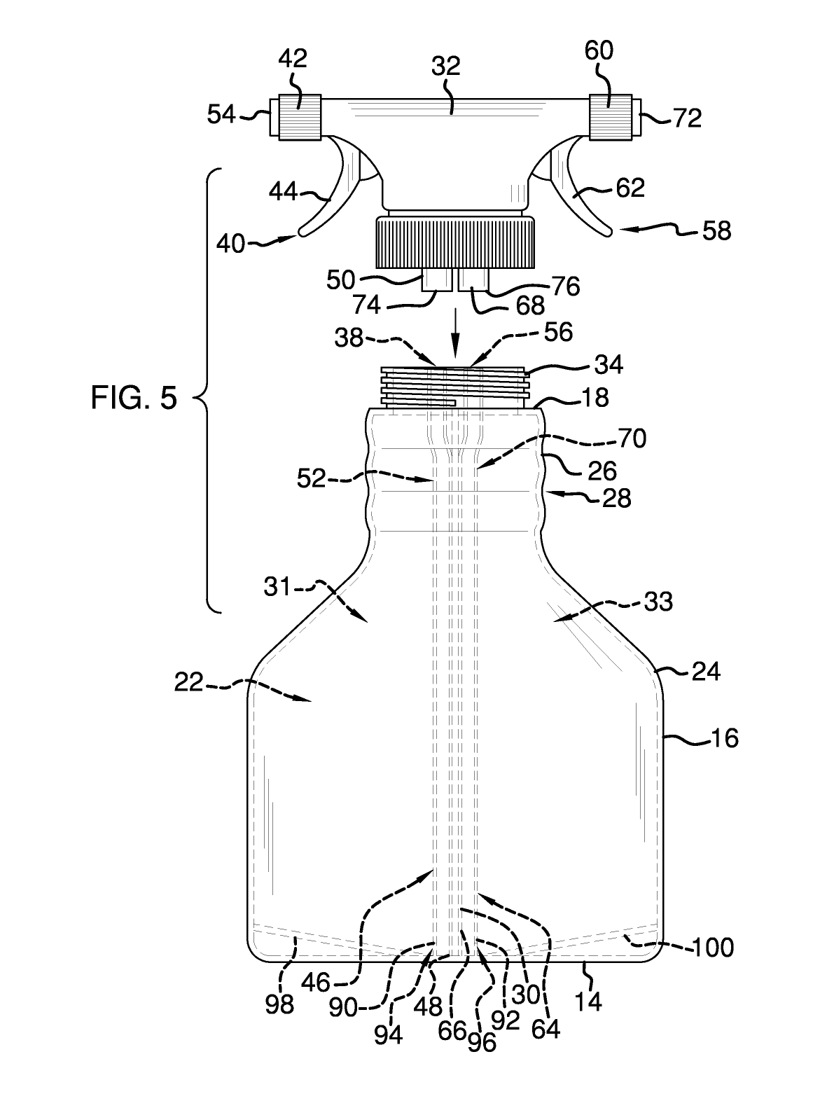

With reference now to the drawings, and in particular to FIGS. 1 through 5 thereof, a new fluid dispensing device embodying the principles and concepts of an embodiment of the disclosure and generally designated by the reference numeral 10 will be described.

As best illustrated in FIGS. 1 through 5, the dual compartment dispensing device 10 generally comprises a container 12 having a bottom wall 14 and a perimeter wall 16 coupled to and extending upwardly from the bottom wall 14. A top edge 18 of the perimeter wall 16 defines an opening 20 into an interior space 22 of the container 12. The perimeter wall 16 of the container 12 comprises a main body section 24 coupled to a neck section 26. The neck section 26 includes the top edge 18. The main body section 24 tapers inwardly toward the neck section 26. The neck section 26 may include a grip 28 to facilitate holding of the container 12.

A dividing wall 30 is positioned in the interior space 22 of the container 12 defining a first compartment 31 configured to receive a first fluid and a second compartment 33 configured to receive a second fluid. The dividing wall 30 extends between the bottom wall 14 and the top edge 18 of the perimeter wall 16 so that the first 31 and second 33 compartments are fluidly separated from each other.

A dispensing head 32 is removably coupled to the container 12. The dispensing head 32 is positionable to cover the opening 20. A threaded lip 34 is attached to the top edge 18 of the perimeter wall 16. The threaded lip 34 extends around the opening 20 into the container 12. The dispensing head 32 is threadably couplable to the threaded lip 34. At least one gasket 36 may be attached to the dispensing head 32 for sealing the dispensing head 32 to the container 12.

A first pump 38 mounted on the dispensing head 32 is in fluid communication with the first compartment 31 wherein the first pump 38 is configured for dispensing the first fluid outwardly of the first compartment 31 when the first pump 38 is actuated. The first pump 38 includes a first actuator 40 coupled to the dispensing head 32 for actuating the first pump 38. A first valve 42 is in fluid communication with the dispensing head 32 and is opened when the first actuator 40 is actuated. A first trigger 44 is coupled to the dispensing head 32. The first trigger 44 is operationally coupled to the first valve 42 such that manipulation of the first trigger 44 opens the first valve 42.

The first pump 38 further includes a first tube 46 in fluid communication with the first compartment 31. The first tube 46 has a lower end 48 wherein the first pump 38 draws the first fluid through the lower end 48 and up the first tube 46 when the first actuator 40 is actuated. The first tube 46 may include an upper section 50 and a lower section 52 removably coupled together. The lower section 52 includes the lower end 48. The upper section 50 extends through the dispensing head 32 and is configured for dispensing the first fluid outwardly of the dispensing head 32. The lower section 52 extends through the first compartment 31. A first dispensing nozzle 54 is in fluid communication with the first tube 46. The first dispensing nozzle 54 is attached to the dispensing head 32.

A second pump 56 mounted on the dispensing head 32 is in fluid communication with the second compartment 33 wherein the second pump 56 is configured for dispensing the second fluid outwardly of the second compartment 33 when the second pump 56 is actuated. The second pump 56 includes a second actuator 58 coupled to the dispensing head 32 for actuating the second pump 56. A second valve 60 is in fluid communication with the dispensing head 32. The second valve 60 is opened when the second actuator 58 is actuated. A second trigger 62 is coupled to the dispensing head 32. The second trigger 62 is operationally coupled to the second valve 60 such that manipulation of the second trigger 62 opens the second valve 60.

The second pump 56 further includes a second tube 64 in fluid communication with the second compartment 33. The second tube 64 has a bottom end 66 wherein the second pump 56 draws the second fluid through the bottom end 66 and up the second tube 64 when the second actuator 58 is actuated. The second tube 64 may include a top section 68 and a bottom section 70 removably coupled together. The bottom section 70 include the bottom end 66. The top section 68 extends through the dispensing head 32 and is configured for dispensing the second fluid outwardly of the dispensing head 32. The bottom section 70 extends through the second compartment 33. A second dispensing nozzle 72 is attached to the dispensing head 32 and is in fluid communication with the second tube 64. The first 54 and the second 72 dispensing nozzles may face in opposite directions with respect to each other. The first dispensing nozzle 54 and the second dispensing nozzle 72 are aligned along a longitudinal axis extending through the dispensing head 32.

The upper section 50 of the first tube 46 and the top section 68 of the second tube 64 each have a respective proximal end 74, 76 with respect to the container 12. The lower section 52 of the first tube 46 and the bottom section 70 of the second tube 64 each has a respective connecting end 78, 80 positioned adjacent to the top edge 18 of the perimeter wall 16. The proximal end 74, 76 of each of the first tube 46 and the second tube 64 is positionable over an associated one of the connecting ends 78, 80 for coupling the upper section 50 to the lower section 52 and the top section 68 to the bottom section 70.

The lower section 52 of the first tube 46 and the bottom section 70 of the second tube 64 are each coupled to the dividing wall 30. The lower section 52 of the first tube 46 and the bottom section 70 of the second tube 64 each has a first side 82 abutting the dividing wall 30 and a second side 84 facing away from the dividing wall 30. The lower end 48 of the first tube 46 and the bottom end 66 of the second tube 64 may each be coupled to the bottom wall 14. The second side 84 of each of the lower section 52 and the bottom section 70 each has a bottom 90, 92 spaced from the bottom wall 14 defining a respective opening 94, 96 configured for allowing the first fluid and the second fluid to be drawn upwardly into the associated first 46 and second 64 tubes.

A first ramp 98 is positioned in the first compartment 31 and extends inwardly from the perimeter wall 16 toward the lower end 48 of the lower section 52 of the first tube 46. The first ramp 98 is aligned with the opening 94 in the first tube 46 and is configured to direct the first fluid toward the opening 94 in the first tube 46. A second ramp 100 is positioned in the second compartment 33 and extends inwardly from the perimeter wall 16 toward the bottom end 66 of the bottom section 70 of the second tube 64. The second ramp 100 is aligned with the opening 96 in the second tube 64 and is configured to direct the second fluid toward the opening 96 in the second tube 64.

In use, the first compartment 31 is filled with a first fluid and the second compartment 33 is filled with a second fluid. The first trigger 44 is manipulated to dispense the first fluid through the first dispensing nozzle 54, while the second trigger 62 is manipulated to dispense the second fluid through the second dispensing nozzle 72. In this manner, the device 10 permits storing and dispensing of multiple fluids independently of each other so that the fluids do not become mixed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dual compartment dispensing device comprising:
a container having a bottom wall and a perimeter wall coupled to and extending upwardly from said bottom wall, a top edge of said perimeter wall defining an opening into an interior space of said container;
a dividing wall positioned in said interior space of said container defining a first compartment configured to receive a first fluid and a second compartment configured to receive a second fluid, said first and second compartments being fluidly separated from each other, said dividing wall extending between said top edge and said bottom wall;
a dispensing head removably coupled to said container, said dispensing head being positionable to cover said opening;
a first pump mounted on said dispensing head and being in fluid communication with said first compartment wherein said first pump is configured for dispensing the first fluid outwardly of said first compartment when said first pump is actuated, said first pump including a first actuator coupled to said dispensing head for actuating said first pump; and
a second pump mounted on said dispensing head and being in fluid communication with said second compartment wherein said second pump is configured for dispensing the second fluid outwardly of said second compartment when said second pump is actuated, said second pump including a second actuator coupled to said dispensing head for actuating said second pump.

2. The device of claim 1, further comprising a threaded lip attached to said top edge of said perimeter wall, said threaded lip extending around said opening into said container, said dispensing head being threadably couplable to said threaded lip.

3. The device of claim 2, further comprising at least one gasket attached to said dispensing head for sealing said dispensing head to said container.

4. The device of claim 1, further comprising:
said first pump including a first valve in fluid communication with said dispensing head, said first valve being opened when said first actuator is actuated; and
said second pump including a second valve in fluid communication with said dispensing head, said second valve being opened when said second actuator is actuated.

5. The device of claim 1, further comprising:
said first actuator including a first trigger coupled to said dispensing head, said first trigger being operationally coupled to said first valve such that manipulation of said first trigger opens said first valve; and
said second actuator including a second trigger coupled to said dispensing head, said second trigger being operationally coupled to said second valve such that manipulation of said second trigger opens said second valve.

6. The device of claim 1, further comprising:
said perimeter wall of said container comprising a main body section coupled to a neck section, said neck section including said top edge, said main body section tapering inwardly toward said neck section; and
said neck section including a grip.

7. The device of claim 1, further comprising:
said first pump further including a first tube in fluid communication with said first compartment, said first tube having a lower end wherein said first pump draws the first fluid through said lower end and up said first tube when said first actuator is actuated; and
said second pump further including a second tube in fluid communication with said second compartment, said second tube having a bottom end wherein said second pump draws the second fluid through said bottom end and up said second tube when said second actuator is actuated.

8. The device of claim 7, further comprising:
said first pump further including a first dispensing nozzle in fluid communication with said first tube, said first dispensing nozzle being attached to said dispensing head; and
said second pump further including a second dispensing nozzle in fluid communication with said second tube, said second dispensing nozzle being attached to said dispensing nozzle.

9. The device of claim 7, further comprising:
said first tube including an upper section and a lower section removably coupled together, said lower section including said lower end of said first tube, said upper section extending through said dispensing head and being configured for dispensing the first fluid outwardly of said dispensing head, said lower section extending through said first compartment; and
said second tube including a top section and a bottom section removably coupled together, said bottom section including said bottom end of said second tube, said top section extending through said dispensing head and being configured for dispensing the second fluid outwardly of said dispensing head, said bottom section extending through said second compartment.

10. The device of claim 9, further comprising said upper section and said top section each having a respective proximal end with respect to said container, said lower section and said bottom section each having a respective connecting end positioned adjacent to said top edge of said perimeter wall, said proximal end of each of said first tube and said second tube being positionable over an associated one of said connecting ends for coupling said upper section to said lower section and said top section to said bottom section.

11. The device of claim 9, further comprising said lower section of said first tube and said bottom section of said second tube each being coupled to said dividing wall.

12. The device of claim 9, further comprising:
said lower end of said first tube and said bottom end of said second tube each being coupled to said bottom wall; and
said lower section of said first tube and said bottom section of said second tube each having a first side abutting said dividing wall and a second side facing away from said dividing wall, said second side of each of said lower section and said bottom section each having a bottom spaced from said bottom wall defining a respective opening configured for allowing the first fluid and the second fluid to be drawn upwardly into said associated first and second tubes.

13. The device of claim 12, further comprising:
a first ramp positioned in said first compartment, said first ramp extending inwardly from said perimeter wall toward said lower end of said lower section of said first tube, said first ramp being aligned with said opening in said first tube and being configured to direct the first fluid toward said opening in said first tube; and
a second ramp positioned in said second compartment, said second ramp extending inwardly from said perimeter wall toward said bottom end of said bottom section of said second tube, said second ramp being aligned with said opening in said second tube and being configured to direct the second fluid toward said opening in said second tube.

14. The device of claim 8, further comprising said first dispensing nozzle and said second dispensing nozzle being aligned along a longitudinal axis extending through said dispensing head.

15. The device of claim 8, further comprising said first and said second dispensing nozzles facing in opposite directions with respect to each other.

16. A dual compartment dispensing device comprising:
a container having a bottom wall and a perimeter wall coupled to and extending upwardly from said bottom wall, a top edge of said perimeter wall defining an opening into an interior space of said container, said perimeter wall of said container comprising a main body section coupled to a neck section, said neck section including said top edge, said main body section tapering inwardly toward said neck section, said neck section including a grip;
a dividing wall positioned in said interior space of said container defining a first compartment configured to receive a first fluid and a second compartment configured to receive a second fluid, said first and second compartments being fluidly separated from each other, said dividing wall extending between said top edge and said bottom wall;
a dispensing head removably coupled to said container, said dispensing head being positionable to cover said opening;
a threaded lip attached to said top edge of said perimeter wall, said threaded lip extending around said opening into said container, said dispensing head being threadably couplable to said threaded lip;
at least one gasket attached to said dispensing head for sealing said dispensing head to said container;
a first pump mounted on said dispensing head and being in fluid communication with said first compartment wherein said first pump is configured for dispensing the first fluid outwardly of said first compartment when said first pump is actuated, said first pump including
a first actuator coupled to said dispensing head for actuating said first pump;
a first valve in fluid communication with said dispensing head, said first valve being opened when said first actuator is actuated;
a first trigger coupled to said dispensing head, said first trigger being operationally coupled to said first valve such that manipulation of said first trigger opens said first valve;
a first tube in fluid communication with said first compartment, said first tube having a lower end wherein said first pump draws the first fluid through said lower end and up said first tube when said first actuator is actuated, said first tube including an upper section and a lower section removably coupled together, said lower section including said lower end, said upper section extending through said dispensing head and being configured for dispensing the first fluid outwardly of said dispensing head, said lower section extending through said first compartment; and
a first dispensing nozzle in fluid communication with said first tube, said first dispensing nozzle is attached to said dispensing head;
a second pump mounted on said dispensing head and being in fluid communication with said second compartment wherein said second pump is configured for dispensing the second fluid outwardly of said second compartment when said second pump is actuated, said second pump including
a second actuator coupled to said dispensing head for actuating said second pump;
a second valve in fluid communication with said dispensing head, said second valve being opened when said second actuator is actuated;
a second trigger coupled to said dispensing head, said second trigger being operationally coupled to said second valve such that manipulation of said second trigger opens said second valve;
a second tube in fluid communication with said second compartment, said second tube having a bottom end wherein said second pump draws the second fluid through said bottom end and up said second tube when said second actuator is actuated, said second tube including a top section and a bottom section removably coupled together, said bottom section including said bottom end, said top section extending through said dispensing head and being configured for dispensing the second fluid outwardly of said dispensing head, said bottom section extending through said second compartment; and
a second dispensing nozzle in fluid communication with said second tube, said second dispensing nozzle being attached to said dispensing nozzle, said first and said second dispensing nozzles facing in opposite directions with respect to each other, said first dispensing nozzle and said second dispensing nozzle being aligned along a longitudinal axis extending through said dispensing head;
said upper section of said first tube and said top section of said second tube each having a respective proximal end with respect to said container, said lower section of said first tube and said bottom section of said second tube each having a respective connecting end positioned adjacent to said top edge of said perimeter wall, said proximal end of each of said first tube and said second tube being positionable over an associated one of said connecting ends for coupling said upper section to said lower section and said top section to said bottom section;
said lower section of said first tube and said bottom section of said second tube each being coupled to said dividing wall;
said lower end of said first tube and said bottom end of said second tube each being coupled to said bottom wall;
said lower section of said first tube and said bottom section of said second tube each having a first side abutting said dividing wall and a second side facing away from said dividing wall, said second side of each of said lower section and said bottom section each having a bottom spaced from said bottom wall defining a respective opening configured for allowing the first fluid and the second fluid to be drawn upwardly into said associated first and second tubes;
a first ramp positioned in said first compartment, said first ramp extending inwardly from said perimeter wall toward said lower end of said lower section of said first tube, said first ramp being aligned with said opening in said first tube and being configured to direct the first fluid toward said opening in said first tube; and
a second ramp positioned in said second compartment, said second ramp extending inwardly from said perimeter wall toward said bottom end of said bottom section of said second tube, said second ramp being aligned with said opening in said second tube and being configured to direct the second fluid toward said opening in said second tube.
